(19) United States
(12) Patent Application Publication
(10) Pub. No.: US 2024/0101820 A1
(43) Pub. Date: Mar. 28, 2024

(54) MOULDING COMPOSITIONS BASED ON POLYAMIDE, GLASS FIBRES AND HOLLOW GLASS REINFORCEMENT AND USE THEREOF

(71) Applicant: ARKEMA FRANCE, COLOMBES (FR)

(72) Inventors: Guillaume VINCENT, CHANGSHU (CN); Mathieu SABARD, SERQUIGNY (FR)

(73) Assignee: ARKEMA FRANCE, COLOMBES (FR)

(21) Appl. No.: 18/266,598

(22) PCT Filed: Dec. 13, 2021
(86) PCT No.: PCT/FR2021/052303

§ 371 Date: Jun. 12, 2023

(30) Foreign Application Priority Data
Dec. 15, 2020 (FR) FR2013225

(51) Int. Cl. C08L 77/02; C08G 69/08; C08G 69/40; C08K 3/40; C08K 7/28

(52) U.S. Cl. CPC C08L 77/02; C08G 69/08; C08G 69/40; C08K 3/40; C08K 7/28; C08G 2120/00; C08K 2201/003; C08K 2201/014; C08L 2205/03; C08L 2205/06

(57) ABSTRACT

The present invention relates to a molding composition, comprising by weight:
(A) 38 to 87% of at least one semi-crystalline aliphatic polyamide,
(B) 3 to 25% of a hollow glass reinforcement,
(C) 5% to 30% glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.,
(E) 0 to 2% by weight of at least one additive,
the sum of the proportions of each constituent of said composition being equal to 100%,
the density of the composition being less than 1.12 g/cm3.

### TECHNICAL FIELD

The present invention relates to molding compositions based on polyamide, glass fibers and hollow glass reinforcements, in particular hollow glass beads and their use for the preparation of articles, especially for manufacturing an article, especially for electronics, for sport, for aircraft, motor vehicles or industry, and having especially good impact strength at 23° C., a good level of elongation, a high rigidity, a good suitability for coloring.

and the density of said composition being less than 1.12 g/cm3.

### PRIOR ART

Articles for electronics, sports, motor vehicle or industrial applications must all become lighter in order to consume less energy or minimize the energy expended when used in the context of sports in particular. They must also allow the athlete to obtain the necessary sensations for controlling movements and rapidly transmitting muscle pulses.

Reinforced polyamides are often used in these applications where the rigidity, tensile strength, lightness, and ductility, in particular between the ambient temperature and very low temperatures (for example −30° C.) of the article comprising these compositions are of great importance.

The density of the polyamides reinforced with glass fibers as measured according to ISO 1183-3:1999 is generally too high for certain applications as mentioned hereinbefore, and especially for sport.

For the sports market, equipment manufacturers are especially looking for very low density polyamide (PA) based materials with good mechanical performances in terms of rigidity, ductility, impact strength mainly and good suitability for coloring.

In order to significantly reduce the density of a material, one of the solutions consists of introducing porosity into the material. Two main techniques can be used: foaming or introducing hollow fillers, for example by a compounding process that is well known to a skilled person.

Thus, international application WO2007/058812 describes compositions comprising a thermoplastic resin and hollow microspheres having a D50 of less than or equal to 25 μm.

U.S. Pat. No. 9,321,906 describes compositions comprising a host resin chosen from a polyamide and a propylene resin and hollow glass microspheres of which the surface is treated with a silane-based coupling agent.

Application US20170058123 describes molding compositions with a density of less than 0.97 g/cm3, comprising an amorphous polyamide, a microcrystalline or partially semi-crystalline polyamide, hollow glass beads and impact modifiers.

One of the main drawbacks of introducing hollow fillers into the compound is that the material with hollow fillers is significantly more fragile than the material without fillers. This can be clearly seen on the elongation at break (after tensile or bending tests) and on the impact strength. Both properties drop considerably and lead to a material that is not suitable for applications.

It is therefore necessary to overcome the problems described hereinbefore.

The present invention relates to a molding composition, comprising by weight:
(A) 38 to 87%, in particular 43 to 89.9 of at least one semi-crystalline aliphatic polyamide,
(B) 3 to 25% of a hollow glass reinforcement, preferably 5 to 25%, in particular 10 to 20%,
(C) 5% to 30% glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.,
(E) 0 to 2% by weight, preferably 0.1 to 1% by weight of at least one additive,
the sum of the proportions of each constituent of said composition being equal to 100%,
said composition having good impact strength, the density of said composition being less than 1.12 g/cm3.

The inventors have therefore found, unexpectedly, that the addition of hollow glass beads and glass fibers, in specific proportion ranges, in impact-modified semi-crystalline aliphatic polyamides made it possible to obtain compositions having a low density of less than 1.12 g/cm3, while still having especially a good impact strength at 23° C., a good level of elongation, a high rigidity, and a good suitability for coloring.

The density of the injected compositions was measured according to standard ISO 1183-3:1999 at a temperature of 23° C. on bars of size 80 mm×10 mm×4 mm.

The elongation at break and tensile strength were measured at 23° C. according to standard ISO 527-1:2012. The machine used is of the INSTRON 5966 type. The speed of the crosshead is set at 1 mm/min for the modulus measurement and 5 mm/min for measuring the elongation and the strain.

The test conditions are 23° C.±2° C., on dry samples.

The impact (or shock) strength was determined according to ISO 179-1:2010/1 eU (Charpy impact) on bars of size 80 mm×10 mm×4 mm, non-notched, at a temperature of 23° C.±2° C. under 50%±10% relative humidity on dry samples.

The suitability for coloring of the composition under D65 illuminant—at 10 degrees.

A Konica Minolta brand spectrophotometer, CM-3610a model is used.

The composition can either be colored black (for example L<30) or colored white (L >65).

### For Constituent A: Semi-Crystalline Aliphatic Polyamide

A semi-crystalline polyamide (PA), in the meaning of the invention, denotes a polyamide that has a melting temperature (Tm) by DSC according to standard ISO 11357-3:2013, and a crystallization enthalpy during the cooling step at a rate of 20 K/min by DSC measured according to standard ISO 11357-3 of 2013 greater than 30 J/g, preferably greater than 40 J/g.

The nomenclature used to define the polyamides is described in ISO 1874-1:2011 standard “Plastics—Polyamide (PA) Moulding And Extrusion Materials—Part 1: Designation” and is well known to a skilled person.

The term “polyamide” used in the present description covers both homopolyamides and copolyamides.

Component (A) comprises 38 to 92% by weight, in particular 43 to 89.9 of at least one semi-crystalline aliphatic polyamide relative to the total weight of the composition.

Said at least one semi-crystalline aliphatic polyamide is obtained from the polycondensation of at least one lactam, or from the polycondensation of at least one amino acid, or from the polycondensation of at least one diamine X with at least one dicarboxylic acid Y.

When said at least one semi-crystalline aliphatic polyamide is obtained from the polycondensation of at least one lactam, it may therefore comprise a single lactam or several lactams.

When said at least one semi-crystalline aliphatic polyamide is obtained from the polycondensation of at least one lactam, said at least one lactam is chosen from a C₆ to C₁₈, preferentially C₈ to C₁₂, more preferentially C₁₀ to C₁₂ lactam.

Advantageously, said at least one semi-crystalline aliphatic polyamide is obtained from the polycondensation of a single lactam and said lactam can be chosen especially from caprolactam, laurolactam and undecanolactam, advantageously laurolactam.

When said at least one semi-crystalline aliphatic polyamide is obtained from the polycondensation of at least one amino acid, said at least one amino acid may be selected from a C6 to C18, preferentially C10 to C18, more preferentially C10 to C12 amino acid.

A C6 to C12 amino acid is especially 6-aminohexanoic acid, 9-aminononanoic acid, 10-aminodecanoic acid, 10-aminoundecanoic acid, 12-aminododecanoic acid and 11-aminoundecanoic acid and derivatives thereof, especially N-heptyl-11-aminoundecanoic acid.

When said at least one semi-crystalline aliphatic polyamide is obtained from the polycondensation of at least one amino acid, it may comprise a single amino acid or several amino acids.

Advantageously, said semi-crystalline aliphatic polyamide is obtained from the polycondensation of a single amino acid and said amino acid is selected from 11-aminoundecanoic acid and 12-aminododecanoic acid, advantageously 11-aminoundecanoic acid.

When said at least one semi-crystalline aliphatic polyamide is obtained from the polycondensation of at least one diamine X with at least one diacid Y, then the diamine is C4-C36, preferentially C6-C18, preferentially C6-C12, more preferentially C10-C12, with at least one C4-C36, preferentially C6-C18, preferentially C6-C12, more preferentially C8-C12 diacid Y, and said at least one diamine X is an aliphatic diamine and said at least one diacid Y is an aliphatic diacid.

The diamine may be linear or branched. Advantageously, it is linear.

Said at least one C4-C36 diamine X may be in particular chosen from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one diamine X is C6-C18 and chosen from 1,6-hexamethylenediamine, 1,7-heptamethylenediamine, 1,8-octamethylenediamine, 1,9-nonamethylenediamine, 1,10-decamethylenediamine 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is in particular chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine.

Advantageously, the diamine X used is a C10 to C12 diamine, in particular chosen from 1,10-decamethylenediamine, 1,11-undecamethylenediamine, 1,12-dodecamethylenediamine.

Said at least one dicarboxylic acid Y is C4 to C36 and may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is C6 to C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

Advantageously, said at least one dicarboxylic acid Y is C6 to C12 and is chosen from adipic acid, suberic acid, azelaic acid, sebacic acid, undecanedioic acid, and dodecanedioic acid.

Advantageously, the average number of carbon atoms relative to the nitrogen atom of the semi-crystalline aliphatic polyamide is greater than or equal to 6.

Advantageously, said at least one dicarboxylic acid Y is C8 to C12 and is chosen from suberic acid, azelaic acid, sebacic acid, undecanedioic acid, and dodecanedioic acid.

Advantageously, said at least one semi-crystalline aliphatic polyamide is obtained from the polycondensation of at least one C7 to C18, preferentially C7 to C12, more preferentially C10 to C12 amino acid, or of at least one C7 to C18, preferentially C7 to C12, more preferentially C10 to C12 lactam.

More advantageously, the average number of carbon atoms relative to the nitrogen atom of the semi-crystalline aliphatic polyamide is greater than or equal to 8.

In particular, the average number of carbon atoms relative to the nitrogen atom of the semi-crystalline aliphatic polyamide is included between 8 and 14.

Advantageously, said semi-crystalline aliphatic polyamide is chosen from PA510, PA512, PA514, PA610, PA612, PA1010, PA1012, PA1212, PA11 and PA 12, in particular PA1010, PA1012, PA1212, PA11, PA 12.

Even more advantageously, the average number of carbon atoms relative to the nitrogen atom of the semi-crystalline aliphatic polyamide is greater than or equal to 9.

Especially, the average number of carbon atoms relative to the nitrogen atom of the semi-crystalline aliphatic polyamide is included between 9 and 14.

More advantageously, the average number of carbon atoms relative to the nitrogen atom of the semi-crystalline aliphatic polyamide is greater than or equal to 10.

Especially, the average number of carbon atoms relative to the nitrogen atom of the semi-crystalline aliphatic polyamide is included between 10 and 14.

Advantageously, said semi-crystalline aliphatic polyamide is chosen from PA11 and PA12, in particular PA11.

In the case of a PA-XY homopolyamide, the number of carbon atoms per nitrogen atom is the mean of unit X and unit Y.

In the case of a copolyamide, the number of carbon atoms per nitrogen atom is calculated according to the same principle. The molar ratios of the various amide units are used for the calculation.

When said semi-crystalline aliphatic polyamide is obtained from the polycondensation of at least one diamine X with at least one dicarboxylic acid Y, it may comprise a single diamine or several diamines and a single dicarboxylic acid or several dicarboxylic acids.

In one embodiment, said semi-crystalline aliphatic polyamide is obtained from the polycondensation of a single diamine X with a single dicarboxylic acid Y.

Advantageously, said semi-crystalline aliphatic polyamide is selected from PA10, PA11, PA12, PA1010, PA1012, particularly PA11 and PA12.

Advantageously, the semi-crystalline polyamide is partially or totally biosourced.

### Regarding Hollow Glass Reinforcement (B)

The hollow glass reinforcement is present in the composition from 3 to 25% by weight, in particular from 5 to 25% by weight, in particular from 10 to 20% by weight relative to the total weight of the composition.

The hollow glass reinforcement corresponds to a glass reinforcement material with a hollow (as opposed to solid) structure that can have any shape as long as it is hollow.

The hollow glass reinforcer can especially be hollow glass fibers or hollow glass beads. In particular, the hollow glass reinforcement is chosen from hollow glass beads.

The short hollow glass fibers preferably have a length of between 2 and 13 mm, preferably 3 to 8 mm, before the compositions are used.

Hollow glass fibers means glass fibers in which the hollow (or hole or window or void) within the fiber is not necessarily concentric relative to the outer diameter of said fiber.

The hollow glass fiber can be:
either with a circular cross-section having an outer diameter from 7 to 75 μm, preferably from 9 to 25 μm, more preferably from 10 to 12 μm.

It is obvious that the diameter of the hollow (the term “hollow” can also be called hole or window or void) is not equal to the outer diameter of the hollow glass fiber.

Advantageously, the diameter of the hollow (or hole or window) is from 10% to 80%, in particular from 60 to 80% of the outer diameter of the hollow fiber.
or with a non-circular cross-section having a L/D ratio (where L represents the largest dimension of the cross-section of the fiber and D the smallest dimension of the cross-section of said fiber) between 2 and 8, in particular between 2 and 4. L and D may be measured by scanning electron microscopy (SEM).

In one embodiment, the hollow glass reinforcement is hollow glass beads.

The hollow glass beads are present in the composition from 3 to 25% by weight, in particular from 5 to 25% by weight, in particular from 10 to 20% by weight relative to the total weight of the composition.

The hollow glass beads have a compressive strength, measured according to ASTM D 3102-72 (1982) in glycerol, of at least 50 MPa and particularly preferably of at least 100 MPa.

Advantageously, the hollow glass beads have a volume mean diameter d₅₀ of 10 to 80 μm, preferably of 13 to 50 μm, measured using laser diffraction in accordance with the standard ASTM B 822-17.

The hollow glass beads can be surface treated with, for example, systems based on aminosilanes, epoxysilanes, polyamides, in particular hydrosoluble polyamides, fatty acids, waxes, silanes, titanates, urethanes, polyhydroxyethers, epoxides, nickel or mixtures thereof can be used for this purpose. The hollow glass beads are preferably surface treated with aminosilanes, epoxysilanes, polyamides or mixtures thereof.

The hollow glass beads can be formed from a borosilicate glass, preferably from a calcium-borosilicate sodium-oxide carbonate glass.

The hollow glass beads preferably have a mean diameter d₅₀ of 10 to 80 μm, preferentially of 13 to 50 μm, as measured by laser diffraction according to ASTM B 822-17.

The distribution is herein expressed in volume.

The hollow glass beads preferably have a real density of 0.10 to 0.65 g/cm³, preferably from 0.20 to 0.60 g/cm³, particularly preferably from 0.30 to 0.50 g/cm³, measured according to the standard ASTM D 2840-69 (1976) with a gas pycnometer and helium as the measuring gas.

Advantageously, the hollow glass beads have a compressive strength, as measured in accordance with ASTM D 3102-72 (1982) in glycerol, of at least 50 MPa, in particular of at least 100 MPa.

In one embodiment, the hollow glass beads are devoid of treatment by a silane-based coupling agent.

### Regarding Glass Fibers (C):

Glass fibers are present from 5% to 30%.

In one embodiment, the glass fibers are present from 12 to 30%.

In yet another embodiment, the glass fibers are present from 5 to 18%.

In yet another embodiment, the glass fibers are present from 5 to 10% by weight relative to the total weight of the composition.

The glass fibers may be solid and/or hollow; advantageously they are solid.

The glass fibers are advantageously short.

Short glass fibers may have a circular or non-circular section.

A fiber with a circular cross-section is defined as a fiber having at any point on its circumference a distance equal to the center of the fiber and thus represents a perfect or near-perfect circle.

Any glass fiber that does not have this perfect or near-perfect circle is therefore defined as a fiber with a non-circular section.

Non-limiting examples of non-circular section fibers are non-circular fibers having, for example, an elliptical, oval or cocoon shape, star shapes, flake shapes, flat fibers, cruciforms, a polygon and a ring.

The short glass fibers preferably have a length of between 2 and 13 mm, preferably 3 to 8 mm, before the compositions are used.

The glass fiber may be:
either with a circular cross-section having a diameter of between 4 μm and 25 μm, preferably between 4 and 15 μm.
or with a non-circular cross-section having a L/D ratio (where L represents the largest dimension of the cross-section of the fiber and D the smallest dimension of the cross-section of said fiber) between 2 and 8, in particular between 2 and 4. L and D may be measured by scanning electron microscopy (SEM).

### Regarding the Impact Modifier (D):

At least one impact modifier is present from 5 to 15% by weight relative to the total weight of the composition.

The at least one impact modifier is chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.

Polyether block amides (PEBA-1) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit X1.Y1 obtained by polycondensation:
of at least one diamine X1, said diamine X1 preferentially being chosen from a linear or branched aliphatic diamine or a mixture thereof, and
of at least one carboxylic diacid Y1, said diacid Y1 preferentially being chosen from:
a linear or branched aliphatic diacid, or a mixture thereof,
said diamine X1 and said diacid Y1 comprising 4 to 36 carbon atoms, advantageously 6 to 18 carbon atoms,
said polyether units (Ba2) being especially derived from at least one polyalkylene ether polyol, especially a polyalkylene ether diol,
PEBA-1s especially result from the copolycondensation of polyamide sequences with reactive ends with polyether sequences with reactive ends, such as, inter alia:
1) Polyamide sequences with diamine chain ends with polyoxyalkylene sequences with dicarboxylic chain ends.
2) Polyamide sequences with dicarboxylic chain ends with polyoxyalkylene sequences with diamine chain ends obtained by cyanoethylation and hydrogenation of alpha-omega dihydroxylated aliphatic polyoxyalkylene sequences referred to as polyalkylene ether diols (polyether diols).
3) Polyamide sequences with dicarboxylic chain ends with polyether diols, the products obtained being, in this particular case, polyether ester amides. The copolymers of the invention are advantageously of this type.

The polyamide sequences with dicarboxylic chain ends come for example from the condensation of polyamide precursors in the presence of a chain-limiting carboxylic diacid.

The polyamide sequences with diamine chain ends come for example from the condensation of polyamide precursors in the presence of a chain-limiting diamine.

The polyamide and polyether block polymers may also comprise randomly distributed units. These polymers may be prepared by the simultaneous reaction of polyether and polyamide block precursors.

For example, polyether diol, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Alternatively, polyether diamine, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

### Amide Unit (Ba1):

The amide unit (Ba1) corresponds to an aliphatic repeating unit as defined above.

Advantageously, the amide unit (Ba1) is chosen from polyamide 11, polyamide 12, polyamide 610, polyamide 612, polyamide 1010, polyamide 1012, in particular polyamide 11.

More advantageously, the amide unit (Ba1) is chosen from polyamide 11 and polyamide 12, in particular polyamide 11.

### Polyether Unit (Ba2):

The polyether units are especially derived from at least one polyalkylene ether polyol, in particular they are derived from at least one polyalkylene ether polyol, in other words, the polyether units consist of at least one polyalkylene ether polyol. In this embodiment, the expression “of at least one polyalkylene ether polyol” means that the polyether units consist exclusively of alcohol chain ends and therefore cannot be a polyether diamine triblock type compound.

The composition of the invention therefore is free of polyether diamine triblock.

Advantageously, the polyether units (Ba2) are chosen from polyethylene glycol (PEG), polypropylene glycol (PPG), polytrimethylene glycol (PO3G), polytetramethylene glycol (PTMG) and the mixtures or copolymers thereof, in particular PTMG.

The number average molecular weight (Mn) of the polyether blocks is advantageously between 200 and 4000 g/mol, preferably between 250 and 2500 g/mol, especially between 300 and 1100 g/mol.

PEBA-1 can be prepared by the following method in which:
in a first step, the polyamide blocks (Ba1) are prepared by polycondensation
of the lactam(s), or
of the amino acid(s), or
of the diamine(s) and of the carboxylic diacid(s); and if necessary, of the comonomer(s) chosen from the lactams and the alpha-omega aminocarboxylic acids;
in the presence of a chain limiter chosen from the carboxylic diacids; then
in a second step, the polyamide blocks (Ba1) obtained are reacted with polyether blocks (Ba2) in the presence of a catalyst.

The general method for two-step preparation of the copolymers of the invention is known and is described, for example, in French patent FR 2 846 332 and in European patent EP 1 482 011.

The reaction for forming the block (Ba1) usually takes place between 180 and 300° C., preferably between 200 and 290° C.; the pressure inside the reactor is between 5 and 30 bar and is maintained for about 2 to 3 hours. The pressure is slowly reduced by bringing the reactor to atmospheric pressure, and then the excess water is distilled off, for example for an hour or two.

Once the polyamide with carboxylic acid ends has been prepared, the polyether and a catalyst are added. The polyether may be added in one or more stages, as can the catalyst. In an advantageous embodiment, the polyether is added first, and the reaction of the OH ends of the polyether and the COOH ends of the polyamide begins with the formation of ester bonds and the removal of water. As much water as possible is removed from the reaction medium by distillation, then the catalyst is introduced to complete the bonding of the polyamide blocks and the polyether blocks. This second step is carried out under stirring, preferably under a vacuum of at least 15 mm Hg (2000 Pa) at a temperature such that the reagents and copolymers obtained are in the molten state. As an example, this temperature can be between 100 and 400° C. and most commonly 200 and 300° C. The reaction is monitored by measuring the torque exerted by the molten polymer on the stirrer or by measuring the electrical power consumed by the stirrer. The end of the reaction is determined by the value of the target torque or power.

One or more molecules used as antioxidant, for example Irganox®1010 or Irganox® 245, may also be added during the synthesis, at the moment deemed most appropriate.

The PEBA preparation process may also be considered so that all the monomers are added at the beginning, in a single step, in order to perform the polycondensation:
of the lactam(s), or
of the amino acid(s), or
of the diamine(s) and the carboxylic diacid(s); and optionally, of the other polyamide comonomer(s);
in the presence of a chain limiter chosen from the carboxylic diacids;
in the presence of the blocks (Ba2) (polyether);
in the presence of a catalyst for the reaction between the soft blocks (Ba2) and the blocks (Ba1).

Advantageously, said carboxylic diacid is used as a chain limiter, which is introduced in excess with respect to the stoichiometry of the diamine(s).

Advantageously, a derivative of a metal chosen from the group formed by titanium, zirconium and hafnium or a strong acid such as phosphoric acid, hypophosphorous acid or boric acid is used as catalyst.

The polycondensation can be carried out at a temperature of 240 to 280° C.

Generally speaking, the known copolymers with ether and amide units consist of linear and semi-crystalline aliphatic polyamide sequences (for example Arkema's “Pebax”).

In one embodiment, the copolyamide with amide units (Ba1) and polyether units (Ba2) has a density greater than or equal to 1, in particular greater than or equal to 1.01, especially greater than or equal to 1.02, as determined in accordance with ISO 1183-3: 1999.

The polyolefin of the impact modifier may be functionalized or non-functionalized or be a mixture of at least one functionalized polyolefin and/or at least one non-functionalized polyolefin. To simplify, the polyolefin is denoted (B) and functionalized polyolefins (B1) and non-functionalized polyolefins (B2) are described below.

A non-functionalized polyolefin (B2) is classically a homopolymer or copolymer of alpha-olefins or diolefins, such as for example, ethylene, propylene, 1-butene, 1-octene, butadiene. By way of example, mention may be made of:
the homopolymers and copolymers of polyethylene, particularly LDPE, HDPE, LLDPE (linear low-density polyethylene), VLDPE (very low density polyethylene) and metallocene polyethylene.
homopolymers or copolymers of propylene.
ethylene/alpha-olefin copolymers such as ethylene/propylene, EPRs (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product selected from the salts or esters of unsaturated carboxylic acids such as alkyl (meth)acrylate (for example methyl acrylate), or the vinyl esters of saturated carboxylic acids such as vinyl acetate (EVA), where the proportion of comonomer can reach 40% by weight.

The functionalized polyolefin (B1) may be a polymer of alpha-olefins having reactive units (functionalities); such reactive units are acid, anhydride, or epoxy functions. Byway of example, mention may be made of the preceding polyolefins (B2) grafted or co- or ter-polymerized by unsaturated epoxides such as glycidyl (meth)acrylate, or by carboxylic acids or the corresponding salts or esters such as (meth)acrylic acid (which may be completely or partially neutralized by metals such as Zn, etc.) or even by carboxylic acid anhydrides such as maleic anhydride.

The functionalized polyolefin (B1) may be chosen from the following, maleic anhydride or glycidyl methacrylate grafted, (co)polymers wherein the graft rate is for example from 0.01 to 5% by weight:
of PE, of PP, of copolymers of ethylene with propylene, butene, hexene, or octene containing for example from 35 to 80% by weight of ethylene;
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
ethylene and vinyl acetate copolymers (EVA), containing up to 40% by weight of vinyl acetate;
ethylene and alkyl (meth)acrylate copolymers, containing up to 40% by weight of alkyl (meth)acrylate;
ethylene and vinyl acetate (EVA) and alkyl (meth)acrylate copolymers, containing up to 40% by weight of comonomers.

The functionalized polyolefin (B1) may also be selected from ethylene/propylene copolymers with predominantly maleic anhydride grafted propylene then condensed with a monoamine polyamide (or a polyamide oligomer) (products described in EP-A-0,342,066).

The functionalized polyolefin (B1) may also be a co- or terpolymer of at least the following units: (1) ethylene, (2) alkyl (meth)acrylate or vinyl ester of saturated carboxylic acid and (3) anhydride such as maleic anhydride or (meth)acrylic acid or epoxy such as glycidyl (meth)acrylate.

By way of example of functionalized polyolefins of the latter type, mention may be made of the following copolymers, where ethylene represents preferably at least 60% by weight and where the termonomer (the function) represents for example from 0.1 to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, (meth)acrylic acid may be salified with Zn or Li.

The term “alkyl (meth)acrylate” in (B1) or (B2) denotes C1 to C8 alkyl methacrylates and acrylates, and may be selected from methyl acrylate, ethyl acrylate, n-butyl acrylate, isobutyl acrylate, 2-ethyl-hexyl acrylate, cyclohexyl acrylate, methyl methacrylate and ethyl methacrylate.

Moreover, the previously cited polyolefins (B1) may also be crosslinked by any appropriate method or agent (diepoxy, diacid, peroxide, etc.); the term functionalized polyolefin also comprises mixtures of the previously cited polyolefins with a difunctional reagent such as a diacid, dianhydride, diepoxy, etc. that can react with these or mixtures of at least two functionalized polyolefins that can react together.

The copolymers mentioned above, (B1) and (B2), may be copolymerized in a statistical or sequenced way and have a linear or branched structure.

The molecular weight, the index MFI, the density of these polyolefins may also vary widely, which the person skilled in the art will know. MFI, abbreviation for Melt Flow Index, is a measure of fluidity in the molten state. It is measured according to standard ASTM 1238.

### Regarding the Additives (E):

The at least one additive is optionally present from 0 to 2% by weight, in particular from 0.1 to 2%, relative to the total weight of the composition.

The additive is chosen from dyes, stabilizers, plasticizers, surfactants, nucleating agents, pigments, whitening agents, antioxidants, lubricants, flame retardants, natural waxes, laser marking additives, and mixtures thereof.

As an example, the stabilizer may be a UV stabilizer, an organic stabilizer or more generally a combination of organic stabilizers, such as a phenol antioxidant (for example of the type Irganox® 245 or 1098 or 1010 by Ciba-BASF), a phosphite antioxidant (for example Irgafos® 126 by Ciba-BASF) and even optionally other stabilizers like a HALS, which means hindered amine light stabilizer (for example Tinuvin® 770 by Ciba-BASF), an anti-UV (for example Tinuvin® 312 by Ciba), a phosphorus-based stabilizer. Amine antioxidants such as Crompton's Naugard® 445 or polyfunctional stabilizers such as Clariant's Nylostab® S-EED can also be used.

This stabilizer may also be a mineral stabilizer, such as a copper-based stabilizer. By way of example of such mineral stabilizers, mention may be made of halides and copper acetates. Secondarily, other metals such as silver may optionally be considered, but these are known to be less effective. These copper-based compounds are typically associated with alkali metal halides, particularly potassium.

By way of example, the plasticizers are selected from benzene sulfonamide derivatives, such as n-butyl benzene sulfonamide (BBSA); ethyl toluene sulfonamide or N-cyclohexyl toluene sulfonamide; hydroxybenzoic acid esters, such as 2-ethylhexyl parahydroxybenzoate and 2-decylhexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

By way of example, the fillers can be selected from silica, graphite, expanded graphite, carbon black, kaolin, magnesia, slag, talc, wollastonite, mica, nanofillers (carbon nanotubes), pigments, metal oxides (titanium oxide), metals, advantageously wollastonite and talc, preferably talc.

By way of example, the laser marking additives are: Iriotec® 8835/Iriotec® 8850 from MERCK and Laser Mark® 1001074-E/Laser Mark® 1001088-E from Ampacet Corporation.

### Regarding the Molding Composition

The molding composition comprises by weight:
(A) 38 to 87%, in particular 43 to 85%, of at least one semi-crystalline aliphatic polyamide,
(B) 3 to 25% of a hollow glass reinforcement, preferably 5 to 25%, in particular 10 to 20%,
(C) 5% to 30% glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.,
(E) 0 to 2% by weight, preferably 0.1 to 1% by weight of at least one additive,
the sum of the proportions of each constituent of said composition being equal to 100%,
the density of the composition being less than 1.12 g/cm3.

Said composition has a low density of less than 1.12 g/cm3, while still having especially good impact strength at 23° C., a good level of elongation, a high rigidity, and a good suitability for coloring.

In one embodiment, the molding composition comprises 0 to 30% by weight of polyether block amide (PEBA-2) having a flexural modulus greater than 100 MPa, in particular greater than 200 MPa, as measured according to standard ISO 178:2010, at 23° C., denoted (F).

Advantageously, said composition consists of:
(A) 38 to 87%, in particular 43 to 85%, of at least one semi-crystalline aliphatic polyamide,
(B) 3 to 25% of a hollow glass reinforcement, preferably 5 to 25%, in particular 10 to 20%,
(C) 5% to 30% glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.,
(E) 0 to 2% by weight, preferably 0.1 to 1% by weight of at least one additive,
(F) 0 to 30% by weight of polyether block amide (PEBA-2) having a flexural modulus greater than 100 MPa, in particular greater than 200 MPa, as measured according to standard ISO 178:2010 at 23° C.,
the sum of the proportions of each constituent of said composition being equal to 100%,
the density of the composition being less than 1.12 g/cm3.

Said composition has a low density of less than 1.12 g/cm3, while still having especially good impact strength at 23° C., a good level of elongation, a high rigidity, and a good suitability for coloring.

More advantageously, said composition consists of:
(A) 38 to 87%, in particular 43 to 85%, of at least one semi-crystalline aliphatic polyamide,
(B) 3 to 25% of a hollow glass reinforcement, preferably 5 to 25%, in particular 10 to 20%,
(C) 5% to 30% glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, in particular less than 100 MPa, as measured according to standard ISO 178:2010, at 23° C.,
(E) 0 to 2% by weight, preferably 0.1 to 1% by weight of at least one additive,
the sum of the proportions of each constituent of said composition being equal to 100%,
the density of the composition being less than 1.12 g/cm3.

Said composition has a low density of less than 1.12 g/cm3, while still having especially good impact strength at 23° C., a good level of elongation, a high rigidity, and a good suitability for coloring.

In a first variant, said composition defined hereinbefore comprises by weight:
(A) 53 to 80%, in particular 54 to 79.9, of at least one semi-crystalline aliphatic polyamide,
(B) 10 to 20% of a hollow glass reinforcement,
(C) 5 to 10% glass fibers,
(D) 5 to 15% of said least one impact modifier,
(E) 0 to 2% by weight, preferably 0.1 to 1% by weight of at least one additive,
the sum of the proportions of each constituent of said composition being equal to 100%.

Advantageously, said composition comprises by weight:
(A) 54 to 79.9 of at least one semi-crystalline aliphatic polyamide, (B) 10 to 20% of a hollow glass reinforcement,
(C) 5 to 10% glass fibers,
(D) 5 to 15% of said least one impact modifier,
(E) 0.1 to 1% by weight of at least one additive,
the sum of the proportions of each constituent of said composition being equal to 100%.

In a first embodiment of this first variant, said molding composition comprises by weight:
(A) 53 to 80%, in particular 54 to 79.9%, of at least one semi-crystalline aliphatic polyamide,
(B) 10% to 20% of a hollow glass reinforcement,
(C) 5 to 10% glass fibers,
(D) 5 to 15% of said at least one polyether block amide (PEBA-1),
(E) 0 to 2% by weight, preferably 0.1 to 1% by weight of at least one additive,
the sum of the proportions of each constituent of said composition being equal to 100%.

Advantageously, said molding composition comprises by weight:
(A) 54 to 79.9% of at least one semi-crystalline aliphatic polyamide,
(B) 10% to 20% of a hollow glass reinforcement,
(C) 5 to 10% glass fibers,
(D) 5 to 15% of said at least one polyether block amide (PEBA-1),
(E) 0.1 to 1% by weight of at least one additive,
the sum of the proportions of each constituent of said composition being equal to 100%.

In a second embodiment of this first variant, said molding composition comprises by weight:
(A) 53 to 80%, in particular 54 to 79.9, of at least one semi-crystalline aliphatic polyamide,
(B) 10% to 20% of a hollow glass reinforcement,
(C) 5 to 10% glass fibers,
(D) 5 to 15% of said at least one polyolefin,
(E) 0 to 2% by weight, preferably 0.1 to 1% by weight of at least one additive,
the sum of the proportions of each constituent of said composition being equal to 100%.

Advantageously, said molding composition comprises by weight:
(A) 54 to 79.9 of at least one semi-crystalline aliphatic polyamide,
(B) 10% to 20% of a hollow glass reinforcement,
(C) 5 to 10% glass fibers,
(D) 5 to 15% of said at least one polyolefin,
(E) 0.1 to 1% by weight of at least one additive,
the sum of the proportions of each constituent of said composition being equal to 100%.

In a third embodiment of this first variant, said molding composition comprises by weight:
(A) 53 to 80%, in particular 54 to 79.9, of at least one semi-crystalline aliphatic polyamide,
(B) 10% to 20% of a hollow glass reinforcement,
(C) 5 to 10% glass fibers,
(D) 5 to 15% of a mixture of said at least one polyolefin and said at least one polyether block amide (PEBA-1)
(E) 0 to 2% by weight, preferably 0.1 to 1% by weight of at least one additive,
the sum of the proportions of each constituent of said composition being equal to 100%.

Advantageously, said molding composition comprises by weight:
(A) 54 to 79.9 of at least one semi-crystalline aliphatic polyamide,
(B) 10% to 20% of a hollow glass reinforcement,
(C) 5 to 10% glass fibers,
(D) 5 to 15% of a mixture of said at least one polyolefin and said at least one polyether block amide (PEBA-1)
(E) 0.1 to 1% by weight of at least one additive,
the sum of the proportions of each constituent of said composition being equal to 100%.

In this first variant, all the embodiments defined hereinbefore can also be carried out with the same compositions but which then consist of the various constituents instead of comprising them.

Advantageously, all the compositions of the various embodiments of this first variant, whether defined by the term “consisting of” or “comprising” are characterized in that said composition has a density less than 1 g/cm3, as determined according to ISO 1183-3:1999.

The compositions of this first variant are especially more particularly suitable for manufacturing a sporting article.

Advantageously, in the compositions defined hereinbefore, including those of the first variant and comprising a PEBA-1, said PEBA-1 has a density greater than or equal to 1 g/cm3, in particular greater than or equal to 1.01 g/cm3, especially greater than or equal to 1.02 g/cm3, as determined according to ISO 1183-3:1999.

Advantageously, in the compositions defined hereinbefore, including those of the first variant and comprising a polyolefin, said polyolefin is functionalized and has a function chosen from the maleic anhydride, carboxylic acid, carboxylic anhydride and epoxide functions, and is in particular chosen from the ethylene/octene copolymers, ethylene/butene copolymers, ethylene/propylene (EPR) elastomers, ethylene-propylene-diene elastomer copolymers (EPDM) and ethylene/alkyl methacrylate copolymers.

In a second variant, said molding composition defined hereinbefore, comprises by weight:
(A) 48 to 78%, in particular 49 to 77.9, of at least one semi-crystalline aliphatic polyamide,
(B) 5% to 25% of a hollow glass reinforcement,
(C) 12% to 30% glass fibers,
(D) 5 to 15% of said least one impact modifier
(E) 0 to 2% by weight, preferably 0.1 to 1% by weight of at least one additive,
the sum of the proportions of each constituent of said composition being equal to 100%.

Advantageously, said molding composition defined hereinbefore, comprises by weight:
(A) 49 to 77.9% of at least one semi-crystalline aliphatic polyamide,
(B) 5% to 25% of a hollow glass reinforcement,
(C) 12% to 30% glass fibers,
(D) 5 to 15% of said least one impact modifier
(E) 0.1 to 1% by weight of at least one additive,
the sum of the proportions of each constituent of said composition being equal to 100%.

In a first embodiment of this second variant, said molding composition comprises by weight:
(A) 48 to 78%, in particular 49 to 77.9, of at least one semi-crystalline aliphatic polyamide,
(B) 5 to 25% of a hollow glass reinforcement,
(C) 12% to 30% glass fibers,
(D) 5 to 15% of said at least one polyether block amide (PEBA-1),
(E) 0 to 2% by weight, preferably 0.1 to 1% by weight of at least one additive,
the sum of the proportions of each constituent of said composition being equal to 100%.

Advantageously, said molding composition defined hereinbefore, comprises by weight:
(A) 49 to 77.9% of at least one semi-crystalline aliphatic polyamide,
(B) 5 to 25% of a hollow glass reinforcement,
(C) 12% to 30% glass fibers,
(D) 5 to 15% of said at least one polyether block amide (PEBA-1),
(E) 0.1 to 1% by weight of at least one additive,
the sum of the proportions of each constituent of said composition being equal to 100%.

In a second embodiment of this second variant, said molding composition comprises by weight:
(A) 48 to 78%, in particular 49 to 77.9, of at least one semi-crystalline aliphatic polyamide,
(B) 5 to 25% of a hollow glass reinforcement,
(C) 12 to 30% glass fibers,
(D) 5% to 15% of said at least one polyolefin,
(E) 0 to 2% by weight, preferably 0.1 to 1% by weight of at least one additive,
the sum of the proportions of each constituent of said composition being equal to 100%.

Advantageously, said molding composition defined hereinbefore, comprises by weight:
(A) 49 to 77.9% of at least one semi-crystalline aliphatic polyamide,
(B) 5 to 25% of a hollow glass reinforcement,
(C) 12 to 30% glass fibers,
(D) 5% to 15% of said at least one polyolefin,
(E) 0.1 to 1% by weight of at least one additive,
the sum of the proportions of each constituent of said composition being equal to 100%.

In a third embodiment of this second variant, said molding composition comprises by weight:
(A) 48 to 78%, in particular 49 to 77.9, of at least one semi-crystalline aliphatic polyamide,
(B) 5% to 25% of a hollow glass reinforcement,
(C) 12 to 30% glass fibers,
(D) 5% to 15% of a mixture of said at least one polyolefin and said at least one polyether block amide (PEBA-1),
(E) 0 to 2% by weight, preferably 0.1 to 1% by weight of at least one additive,
the sum of the proportions of each constituent of said composition being equal to 100%.

Advantageously, said molding composition defined hereinbefore, comprises by weight:
(A) 49 to 77.9% of at least one semi-crystalline aliphatic polyamide,
(B) 5% to 25% of a hollow glass reinforcement,
(C) 12 to 30% glass fibers,
(D) 5% to 15% of a mixture of said at least one polyolefin and said at least one polyether block amide (PEBA-1),
(E) 0.1 to 1% by weight of at least one additive,
the sum of the proportions of each constituent of said composition being equal to 100%.

In this second variant, all the embodiments defined hereinbefore can also be carried out with the same compositions but which then consist of the various constituents instead of comprising them.

Advantageously, all the compositions of the various embodiments of this first variant, whether defined by the term “consisting of” or “comprising” are characterized in that said composition has a density from 1.0 to less than 1.12 as determined according to ISO 1183-3:1999.

The compositions of this second variant are especially more particularly suitable for manufacturing an electronic or aircraft article.

Advantageously, in the compositions hereinbefore defined in the second variant and comprising a PEBA-1, said PEBA-1 has a density greater than or equal to 1 g/cm3, in particular greater than or equal to 1.01 g/cm3, especially greater than or equal to 1.02 g/cm3, as determined according to ISO 1183-3:1999.

Advantageously, in the compositions hereinbefore defined in the second variant and comprising a polyolefin, said polyolefin is functionalized and has a function chosen from the maleic anhydride, carboxylic acid, carboxylic anhydride and epoxide functions, and is in particular chosen from the ethylene/octene copolymers, ethylene/butene copolymers, ethylene/propylene (EPR) elastomers, ethylene-propylene-diene elastomer copolymers (EPDM) and ethylene/alkyl methacrylate copolymers.

The dielectric constant is defined as the ratio of the permittivity ε of the material under consideration to the permittivity of vacuum. It is noted k or Dk and is measured according to ASTM D-2520-13. This is the relative permittivity.

It is measured under 50% relative humidity (RH) at 23° C. on a sample that has been previously dried, especially at 80° C. for 5 days.

A frequency of 1 GHz corresponds to 109 Hz in scientific notation.

Advantageously, the compositions hereinbefore defined in this second variant exhibit a low dielectric constant Dk. Especially, said dielectric constant Dk is less than or equal to 3.5, especially less than or equal to 3.4, as measured according to ASTM D-2520-13, at a frequency of at least 1 GHz, especially at a frequency of at least 2 GHz, in particular at a frequency of at least 3 GHz, at 23° C., under 50% RH.

A distinction is made between different moduli (e.g. tensile modulus, flexural modulus, etc.). If we consider the flexural modulus, it is always lower than the tensile modulus.

These moduli may be impacted by temperature and by the moisture level in the sample.

Advantageously, the compositions hereinbefore defined in this second variant have a high modulus. Especially, said dry modulus at 20° C. is from 1.5 GPa to less than 6 GPa, in particular from 3 GPa to less than 6 GPa.

In one embodiment, the above defined modulus corresponds to both the flexural modulus and the tensile modulus, the flexural modulus being measured according to ISO 178:2010 and the tensile modulus (or modulus of elasticity E) being measured according to ISO 527-1 and 2:2012.

In another embodiment, the above defined modulus corresponds to the flexural modulus and is measured as above.

In another embodiment, the above defined modulus corresponds to the tensile modulus and is measured as above.

Advantageously in this second variant, the semi-crystalline aliphatic polyamide has an average number of carbon atoms per nitrogen atom greater than or equal to 8 and the water stability of the compositions is greater than that of a composition having an average number of carbon atoms per nitrogen atom of less than 8

According to another aspect, the present invention relates to the use of a composition as defined hereinbefore, for manufacturing an article, especially for electronics, sports, aircraft, motor vehicles or industry.

Advantageously, said article is manufactured by injection molding.

According to another aspect, the present invention relates to an article obtained by injection molding with a composition as defined hereinbefore.

### EXAMPLES

### Preparation of the Compositions of the Invention and Mechanical Properties:

The compositions of Tables 1 and 2 were prepared by melt-blending granules of polyamide, PEBA and/or polyolefin with the hollow glass beads and the glass fibers and optionally the additives.

This mixture was made by compounding on a 26 mm diameter twin-screw co-rotating extruder with a flat temperature profile (T°) at 250° C. The screw speed is 250 rpm and the flow rate is 15 kg/h.

The introduction of the hollow glass beads and the glass fibers is carried out with a side feeder.

The semi-crystalline aliphatic polyamide, the PEBA(s), the polyolefin(s) and the additives are added to the main hopper.

The compositions were then molded on an injection molding machine (Engel) at a setpoint temperature of 220° C. and a molding temperature of 50° C. in the shape of dumbbells or bars in order to study the properties of the compositions according to the standards below.

The tensile modulus was measured at 23° C. according to ISO standard 527-1:2012 on dumbbells of type 1A. The elongation at break and tensile strength were also measured at 23° C. according to the same standard ISO 527-1:2012. The machine used is of the INSTRON 5966 type. The speed of the crosshead is set at 1 mm/min for the modulus measurement and 5 mm/min for measuring the elongation and the strain.

The test conditions are 23° C.±2° C., on dry samples.

The flexural modulus was measured according to standard ISO 178:2010 on test specimens of compositions at 23° C. and on dry samples. The machine used is also of the INSTRON 5966 type.

The impact strength was determined according to ISO 179-1:2010/1 eU (Charpy impact) on bars of size 80 mm×10 mm×4 mm, non-notched, at a temperature of 23° C.±2° C. under 50%±10% relative humidity on dry samples.

The density of the injected compositions was measured according to standard ISO 1183-3:1999 at a temperature of 23° C. on bars of size 80 mm×10 mm×4 mm.

The suitability for coloring of the composition under D65 illuminant at 10 degrees.

A Konica Minolta brand spectrophotometer, CM-3610a model is used and makes it possible to determine the color parameters L, a and b.

L is the parameter that makes it possible to measure the white/gray/black level.

The composition is suitable for being colored black if L<30 and white if L >65.

TABLE 1

| % (by weight) | CE1 | CE2 | I1 | I2 | I3 | I4 | I5 | I6 | I7 | I8 |
|---|---|---|---|---|---|---|---|---|---|---|
| PA11 | 79 | 91.7 | 65.3 | 65.3 | 62.9 | 64.5 | 64.5 | 65.3 | 70.3 | 70.3 |
| PEBA | 13.9 | — | 12.6 | | | 5.4 | 8.0 | 6.3 | 12.6 | — |
| PA11/PTMG | | | | | | | | | | |
| (1000/1000 g/mol) | | | | | | | | | | |
| TAFMER ® MH5020 | — | — | | 12.6 | 15 | 8.0 | 5.4 | | — | — |
| Exxelor VA1840 | — | — | — | — | — | — | — | 6.3 | — | 12.6 |
| Antioxidant | 0.3 | 0.3 | 0.3 | 0.3 | 0.3 | 0.3 | 0.3 | 0.3 | 0.3 | 0.3 |
| E glass fibers with a | 6.8 | 8.0 | 6.8 | 6.8 | 6.8 | 6.8 | 6.8 | 6.8 | 6.8 | 6.8 |
| circular cross-section | | | | | | | | | | |
| of diameter 10.5 μm | | | | | | | | | | |
| Hollow glass beads | — | — | 15.0 | 15.0 | 15.0 | 15.0 | 15.0 | 15.0 | 10 | 10 |
| Total (%) | 100 | 100 | 100.0 | 100.0 | 100.0 | 100.0 | 100.0 | 100.0 | 100 | 100 |
| Density (g/cm³) | 1.07 | 1.08 | 0.98 | 0.98 | 0.97 | 0.97 | 0.98 | 0.98 | 0.99 | 0.99 |
| Suitability for coloring | OK | OK | OK | OK | OK | OK | OK | OK | OK | OK |
| (black) | | | | | | | | | | |
| Suitability for coloring | OK | OK | OK | OK | OK | OK | OK | OK | OK | OK |
| (white) | | | | | | | | | | |
| Flexural modulus | 1.6 | 1.7 | 1.9 | 1.9 | 1.6 | 1.8 | 1.8 | 1.9 | 1.8 | 1.7 |
| (GPa) | | | | | | | | | | |
| Tensile modulus (GPa) | 1.8 | 2.3 | 2.1 | 2.1 | 1.9 | 2.2 | 2.2 | 2.2 | 2.0 | 2.0 |
| Break on lengthening | 10.6 | 26.0 | 5.8 | 14.5 | 17.5 | 7.9 | 7.2 | 8.0 | 7.3 | 7.9 |
| (%) | | | | | | | | | | |
| Tensile strength (MPa) | 56.0 | 56.0 | 50.2 | 44.8 | 42.2 | 42.4 | 42.8 | 55.5 | 52.4 | 51.4 |
| Non-notched Charpy | 80 | 90 | 56 | 69 | 81 | 54 | 48 | 52 | 72 | 75 |
| impact according to | | | | | | | | | | |
| ISO 179-1: 2010/1eU | | | | | | | | | | |
| strength (kJ/m²) at | | | | | | | | | | |
| 23° C. | | | | | | | | | | |

PA11: produced by Arkema
PEBA PA11/PTMG (1000/1000 g/mol) produced by ARKEMA
Tafmer ® MH5020: maleic anhydride-grafted ethylene-butene copolymer marketed by Mitsui Chemicals

Exxelor VA1840 provided by ExxonMobil.

E glass fibers: solid glass fibers with a circular cross-section of diameter 10 μm and type E (Nitto Boseki or Nippon Electric Glass)

Hollow glass beads: HK60-18000 (Hollowlite)

The compositions of examples 11 to 18 according to the invention (Table 1) have good impact strength at 23° C., a good level of elongation, a very low density (density strictly less than 1), and a good suitability for coloring.

TABLE 2

| % (by weight) | CE3 | I9 | I10 | I11 | I12 |
|---|---|---|---|---|---|
| PA11 | 84.7 | 74.7 | 59.7 | 54.7 | 54.7 |
| PEBA | | 5.0 | 5.0 | | |
| PA11/PTMG | | | | | |
| (1000/1000 g/mol) | | | | | |
| VA1803 | — | — | — | 10.0 | — |
| FG1901 | — | — | — | — | 10 |
| Antioxidant | 0.3 | 0.3 | 0.3 | 0.3 | 0.3 |
| E glass fibers with a | 15 | 15 | 15 | 15 | 15 |
| circular cross-section | | | | | |
| Hollow glass beads | — | 5.0 | 20.0 | 20.0 | 20.0 |
| Total | 100 | 100.0 | 100.0 | 100.0 | 100.0 |
| Density (g/cm³) | 1.13 | 1.09 | 1.02 | 0.99 | 1.00 |
| Suitability for | OK | OK | OK | OK | OK |
| coloring (black) | | | | | |
| Suitability for | OK | OK | OK | OK | OK |
| coloring (white) | | | | | |
| Flexural modulus (GPa) | 4.0 | 4.3 | 5.3 | 4.6 | 4.7 |
| Tensile modulus (GPa) | 4.2 | 4.4 | 5.6 | 4.8 | 5.0 |
| Break on | 10.3 | 7.8 | 4.9 | 5.4 | 3.5 |
| lengthening (%) | | | | | |
| Tensile strength (MPa) | 74.0 | 77.0 | 80.0 | 64.0 | 63.0 |
| Non-notched Charpy | 75 | 56 | 48 | 52 | 62 |
| impact according to | | | | | |
| ISO 179-1: 2010/1 eU | | | | | |
| strength (kJ/m²) | | | | | |
| at 23° C. | | | | | |

PA11: produced by Arkema
EXXELOR ™ VA 1803: provided by ExxonMobil. Maleic anhydride-grafted ethylene copolymer
Kraton ™ FG1901: supplied by Kraton. Ethylene and styrene-butene copolymer
Tafmer ® MH5020: maleic anhydride-grafted ethylene-butene copolymer marketed by Mitsui Chemicals
E glass fibers: solid glass fibers with a circular cross-section of diameter 10 μm and type E (provided by Nitto Boseki or Nippon Electric Glass)
Hollow glass beads: HK60-18000 (supplied by Hollowlite)

The compositions of examples 19 to 112 according to the invention (Table 1l) have good impact strength at 23° C., a good level of elongation, a high rigidity, and a good suitability for coloring while maintaining a low density of less than 1.12 g/cm3.

1. A molding composition, comprising by weight:
(A) 38 to 87% of at least one semi-crystalline aliphatic polyamide, said semi-crystalline aliphatic polyamide having an average number of carbon atoms relative to the nitrogen atom greater than or equal to 8,
(B) 3 to 25% of hollow glass beads,
(C) 5% to 30% solid glass fibers,
(D) 5 to 15% of at least one impact modifier chosen from a polyolefin, a polyether block amide (PEBA-1) and a mixture thereof, the polyolefin and the PEBA-1 having a flexural modulus less than 200 MPa, as measured according to standard ISO 178:2010, at 23° C.,
(E) 0 to 2% by weight of at least one additive,
the sum of the proportions of each constituent of said composition being equal to 100%,
the density of said composition being less than 1.12 g/cm3, as measured according to ISO 1183-3:1999.

2. The molding composition according to claim 1, wherein it comprises by weight:
(A) 53 to 80% of at least one semi-crystalline aliphatic polyamide,
(B) 10 to 20% of hollow glass beads,
(C) 5 to 10% solid glass fibers,
(D) 5 to 15% of said least one impact modifier,
(E) 0 to 2% by weight of at least one additive,
the sum of the proportions of each constituent of said composition being equal to 100%.

3. The molding composition according to claim 2, wherein it comprises by weight:
(A) 53 to 80% of at least one semi-crystalline aliphatic polyamide,
(B) 10% to 20% of hollow glass beads,
(C) 5 to 10% solid glass fibers,
(D) 5 to 15% of said at least one polyether block amide (PEBA-1),
(E) 0 to 2% by weight of at least one additive,
the sum of the proportions of each constituent of said composition being equal to 100%.

4. The molding composition according to claim 2, wherein it comprises by weight:
(A) 53 to 80% of at least one semi-crystalline aliphatic polyamide,
(B) 10% to 20% of hollow glass beads,
(C) 5 to 10% solid glass fibers,
(D) 5 to 15% of said at least one polyolefin,
(E) 0 to 2% by weight of at least one additive,
the sum of the proportions of each constituent of said composition being equal to 100%.

5. The molding composition according to claim 2, wherein it comprises by weight:
(A) 53 to 80% of at least one semi-crystalline aliphatic polyamide,
(B) 10% to 20% of hollow glass beads,
(C) 5 to 10% solid glass fibers,
(D) 5 to 15% of a mixture of said at least one polyolefin and said at least one polyether block amide (PEBA-1)
(E) 0 to 2% by weight of at least one additive,
the sum of the proportions of each constituent of said composition being equal to 100%.

6. The composition according to claim 2, wherein said composition has a density greater than or equal to 1 g/cm3, as determined according to ISO 1183-3:1999.

7. The molding composition according to claim 1, wherein it comprises by weight:
(A) 48 to 78% of at least one semi-crystalline aliphatic polyamide,
(B) 5% to 25% of hollow glass beads,
(C) 12% to 30% solid glass fibers,
(D) 5 to 15% of said least one impact modifier
(E) 0 to 2% by weight of at least one additive,
the sum of the proportions of each constituent of said composition being equal to 100%.

8. The molding composition according to claim 7, wherein it comprises by weight:
(A) 48 to 78% of at least one semi-crystalline aliphatic polyamide,
(B) 5 to 25% of hollow glass beads,
(C) 12% to 30% solid glass fibers,
(D) 5 to 15% of said at least one polyether block amide (PEBA-1),
(E) 0 to 2% by weight of at least one additive,
the sum of the proportions of each constituent of said composition being equal to 100%.

9. The molding composition according to claim 7, wherein it comprises by weight:
(A) 48 to 78% of at least one semi-crystalline aliphatic polyamide,
(B) 5 to 25% of hollow glass beads,
(C) 12 to 30% solid glass fibers,
(D) 5% to 15% of said at least one polyolefin,
(E) 0 to 2% by weight of at least one additive,
the sum of the proportions of each constituent of said composition being equal to 100%.

10. The molding composition according to claim 7, wherein it comprises by weight:
(A) 48 to 78% of at least one semi-crystalline aliphatic polyamide,
(B) 5% to 25% of hollow glass beads,
(C) 12 to 30% solid glass fibers,
(D) 5% to 15% of a mixture of said at least one polyolefin and said at least one polyether block amide (PEBA-1),
(E) 0 to 2% by weight of at least one additive,
the sum of the proportions of each constituent of said composition being equal to 100%.

11. The composition according to claim 7, wherein said composition has a density of 1.0 g/cm3 to less than 1.12 g/cm3 as determined according to ISO 1183-3:1999.

12. The composition according to claim 1, wherein the PEBA-1 has a density greater than or equal to 1, as determined according to ISO 1183-3:1999.

13. The composition according to claim 1, wherein the functionalized polyolefin has a function chosen from the maleic anhydride, carboxylic acid, carboxylic anhydride and epoxide functions.

14. The composition according to claim 1, wherein the hollow glass beads have a mean diameter d₅₀ of 10 to 80 μm, as measured by laser diffraction according to ASTM B 822-17.

15. The composition according to claim 1, wherein the hollow glass beads have a real density of 0.10 to 0.65 g/cm³, measured according to ASTM D 2840-69 (1976) with a gas pycnometer and helium as the measuring gas.

16. The composition according to claim 1, wherein the hollow glass beads have a compressive strength, as measured in accordance with ASTM D 3102-72 (1982) in glycerol, of at least 50 MPa.

17. The composition according to claim 1, wherein the semi-crystalline polyamide is obtained by polycondensation:
of at least one C₆ to C₁₈ amino acid, or
of at least one C₆ to C₁₈ lactam, or
of at least one C₄-C₃₆ aliphatic diamine X with at least one C₄-C₃₆ aliphatic dicarboxylic acid Y, or
a mixture thereof.

18. The composition according to claim 1, wherein the semi-crystalline polyamide is obtained by polycondensation:
of at least one C₇ to C₁₈ amino acid, or
of at least one C₇ to C₁₈ lactam.

19. The composition according to claim 1, wherein said semi-crystalline aliphatic polyamide is chosen from PA610, PA612, PA1010, PA1012, PA1212, PA11 and PA 12.

20. The composition according to claim 1, wherein said semi-crystalline aliphatic polyamide is chosen from PA11 and PA12.

21. The composition according to claim 1, wherein said at least one additive is chosen from fillers, dyes, stabilizers, plasticizers, surfactants, nucleating agents, pigments, whitening agents, antioxidants, lubricants, flame retardants, natural waxes, impact modifiers and mixtures thereof.

22. A method of using a composition as defined in claim 1, for the manufacture of an article.

23. The method according to claim 22, wherein the article is manufactured by injection molding.

24. An article obtained by injection molding with a composition as defined in claim 1.
